(19) United States
(12) Patent Application Publication
(10) Pub. No.: US 2025/0316166 A1
(43) Pub. Date: Oct. 9, 2025

(54) METHOD FOR OPERATING AN ELECTRONIC TRAFFIC SIGNALING DEVICE AND FOR OPERATING A MOTOR VEHICLE

(71) Applicant: Robert Bosch GmbH, Stuttgart (DE)

(72) Inventors: Michael Gabb, Gaeufelden (DE); Nico Latsch, Oppenweiler (DE); Stefan Nordbruch, Leonberg (DE); Uwe Wilbrand, Leutenbach (DE)

(21) Appl. No.: 19/075,857

(22) Filed: Mar. 11, 2025

(30) Foreign Application Priority Data
Apr. 4, 2024 (DE) 10 2024 203 107.0

(51) Int. Cl. G08G 1/07; G08G 1/09

(52) U.S. Cl. CPC G08G 1/07; G08G 1/091

(57) ABSTRACT

A method for operating an electronic traffic signaling device. The method includes: visually displaying actual information by means of an electronic display device of the traffic signaling device; generating and transmitting a radiogram comprising the actual information by means of the traffic signaling device; checking whether the displayed actual information matches a target information; if it does not match, correcting the visually displayed information in order to visually display new actual information by means of the electronic display device; and generating and transmitting a new radiogram comprising the new actual information by means of the traffic signaling device. A method for operating a motor vehicle, a traffic signaling device, a computer program, a device, a computer program and a machine-readable storage medium, are also described.

### CROSS REFERENCE

The present application claims the benefit under 35 U.S.C. § 119 of German Patent Application No. DE 10 2024 203 107.0 filed on Apr. 4, 2024, which is expressly incorporated herein by reference in its entirety.

### FIELD

The present invention relates to a method for operating an electronic traffic signaling device, a method for operating a motor vehicle, a traffic signaling device, a computer program, a device, a computer program and a machine-readable storage medium.

### BACKGROUND INFORMATION

U.S. Patent Application No. US 2022/0081011 A1 describes a method for controlling the operation of a vehicle.

PCT Patent Application No. WO 2022/154885 A1 describes a method for exchanging information between an automated vehicle and a signal system.

China Patent Application No. CN 111223308 A describes a method for communication between a traffic observation module and an evaluation unit.

### SUMMARY

An object of the present invention is to provide a method for operating an electronic traffic signaling device.

An object of the present invention is to provide a method for operating a motor vehicle.

An object of the present invention is to provide a traffic signaling device.

An object of the present invention is to provide a device.

An object of the present invention is to provide a computer program.

An object of the present invention is to provide a machine-readable storage medium.

These objects are achieved by various features of the present invention. Advantageous example embodiments of the present invention are disclosed herein.

According to a first aspect of the present invention, a method for operating an electronic traffic signaling device, in particular a traffic light system or an electronic traffic sign is provided. According to an example embodiment of the present invention, the method comprises the following steps:
visually displaying actual information by means of an electronic display device of the traffic signaling device,
generating and transmitting a radiogram comprising the actual information by means of the traffic signaling device,
checking whether the displayed actual information matches a target information,
if it does not match, correcting the visually displayed information in order to visually display new actual information by means of the electronic display device, and
generating and transmitting a new radiogram comprising the new actual information by means of the traffic signaling device.

According to a second aspect of the present invention, a method for operating a motor vehicle is provided. According to an example embodiment of the present invention, the method comprises the following steps:
when the motor vehicle receives a radiogram transmitted by an electronic traffic signaling device, in particular a traffic light system or an electronic traffic sign, outside of a heartbeat-based cycle, checking by the motor vehicle the radiogram received outside of the heartbeat-based cycle for correctness of the radiogram, operating the motor vehicle depending on the check for correctness.

According to a third aspect of the present invention, a traffic signaling device, in particular a traffic light system or an electronic traffic sign is provided. According to an example embodiment of the present invention, the traffic signaling device comprises:
an electronic display device, which is configured to visually display actual information,
a generating device, which is configured to generate a radiogram comprising the actual information,
a transmitting device, which is configured to transmit the generated radiogram,
a checking device, which is configured to check whether the displayed actual information matches a target information,
a correcting device, which is configured to correct the visually displayed information if it does not match in order to visually display a new actual information by means of the visual display,
wherein the generating device is configured to generate a new radiogram comprising the new actual information, and
wherein the transmitting device is configured to transmit the new radiogram.

According to a fourth aspect of the present invention, a device is provided, which is configured to carry out all steps of the method according to the second aspect of the present invention.

According to a fifth aspect of the present invention, a computer program is provided, which comprises instructions that, when the computer program is executed by a computer, in particular by the traffic signaling device according to the third aspect of the present invention and/or by the device according to the fourth aspect of the present invention, cause said computer to carry out a method according to the first aspect of the present invention and/or according to the second aspect of the present invention.

According to a sixth aspect of the present invention, a machine-readable storage medium is provided, on which the computer program according to the fifth aspect of the present invention is stored.

The fact that, if the displayed actual information does not match a target information, the traffic signaling device corrects the visually displayed information in order to visually display new actual information and also transmits a new radiogram which includes the new actual information, for instance produces the technical advantage that the new actual information can be efficiently made available to traffic participants in the vicinity of the traffic signaling device. On the one hand, traffic participants can acquire the latest information visually, for example using a video camera or by sight, provided the traffic participant is a person or a driver of a motor vehicle or a bicycle. On the other hand, the new actual information can be received wirelessly by the traffic participant, so that a line of sight to the traffic signaling device is not necessarily needed for the traffic participant to become aware of the new actual information.

The new actual information can thus be efficiently distributed or made available to traffic participants in the vicinity of the traffic signaling device.

It is therefore in particular provided that, when it has been recognized that the visually or optically displayed signal, here the actual information, does not match what is in fact supposed to be displayed by the display device, the traffic signaling device corrects the optically or visually displayed information and generates and transmits a new radiogram with corrected content, i.e. with the new actual information.

On the motor vehicle side, it is common that radiograms are received from traffic signaling devices using a heartbeat-based cycle, so that, if a radiogram is not received outside the heartbeat, it can be inferred that there is an error in the communication between the traffic signaling device and the motor vehicle, for instance, or that there is an error in the traffic signaling device, so that the motor vehicle can react appropriately; for example, the motor vehicle is operated on the basis of a safety concept.

However, it can happen that the traffic signaling device has to generate and transmit a new radiogram based on the above statements, which is then transmitted outside of a heartbeat-based cycle.

According to example embodiments of the present invention described in the description, it is now provided on the motor vehicle side that errors in the communication between the traffic signaling device and the motor vehicle or errors in the traffic signaling device cannot be automatically inferred. It is instead provided that the radiogram received outside of the heartbeat-based cycle is checked for correctness, and the motor vehicle is operated based on a result of said check for correctness or depending on the check for correctness. The motor vehicle can therefore react appropriately to a radiogram received outside of the heartbeat-based cycle. Such a radiogram does not necessarily mean that there is an error, but it can be an indication that something has changed in the status of the traffic signaling device or that there is a difference between the optical or visual display and the state of the traffic signaling device digitally transmitted before as a radiogram.

The motor vehicle can thus be operated efficiently.

In one example embodiment of the method according to the first aspect of the present invention, it is provided that the radiogram comprising the actual information is transmitted using a heartbeat-based cycle, wherein it is determined that the new radiogram comprising the new actual information may be transmitted outside of the heartbeat-based cycle, so that the new radiogram is transmitted immediately after being generated without waiting until the next cycle to transmit.

This, for example, produces the technical advantage that the new actual information can be transmitted without unnecessary delay.

In one example embodiment of the method according to the first aspect of the present invention, it is provided that the radiograms are generated such that they comprise one or more of the following additional information: type of traffic signaling device; position of the traffic signaling device; application range of the traffic signaling device; in the case of a traffic light system, information relating to signal group(s); in the case of a traffic light system, information relating to an assignment to lane(s); in the case of an electronic traffic sign, height of the traffic sign; in the case of an electronic traffic sign, assignment to lane(s).

This, for example, produces the technical advantage that useful and suitable information is made available to traffic participants, in particular motor vehicles, based on which the motor vehicles can, for instance, assign the received radiogram to the traffic signaling device.

In one example embodiment of the method according to the first aspect of the present invention, it is provided that checking includes optical checking by means of an optical sensor of the traffic signaling device.

This, for example, produces the technical advantage that checking can be carried out efficiently. The optical sensor is an image sensor of a video camera, for instance.

In one example embodiment of the method according to the first aspect of the present invention, it is provided that the radiograms are generated such that they comprise a value of a counter that is incremented or decremented after transmission of a radiogram.

This, for example, produces the technical advantage that the order in which the radiograms are transmitted is efficiently identified. On the motor vehicle side, this makes it possible to efficiently check whether a received radiogram is an outdated radiogram, for example a radiogram that has been transmitted too late.

In one example embodiment of the method according to the second aspect of the present invention, it is provided that checking for correctness includes checking for formal and/or content correctness.

This, for example, produces the technical advantage that checking can be carried out efficiently.

Checking for formal correctness in particular means checking whether the radiogram satisfies formal condition(s) in formal terms, for example the safety condition(s) described in the following.

In one example embodiment of the method according to the second aspect of the present invention, it is provided that checking for formal correctness includes checking whether at least one safety condition is satisfied by the radiogram.

This, for example, produces the technical advantage that checking for formal correctness can be carried out efficiently. The radiogram includes a checksum of the information in the radiogram, for instance, wherein checking for formal correctness includes checking the checksum. The safety condition that has to be satisfied here is that checking the checksum has shown that the checksum is correct. For example, a checksum of the information in the radiogram is calculated and compared with the checksum in the radiogram. If they match, the checksum is correct and safety condition is satisfied. If not, the checksum is not correct and the safety condition is not satisfied.

Checking for formal correctness includes checking a sender of the radiogram, for example. The radiogram can be signed by a private key or by a private certificate, for instance, so that the signature can be checked by a public key or public certificate belonging to a public key or public certificate associated with the private key or public certificate. The safety condition that has to be satisfied here is that the signature of the radiogram matches a public key or public certificate associated with the traffic signaling device.

In one example embodiment of the method according to the second aspect of the present invention, it is provided that checking for content correctness includes comparing signal information of the traffic signaling device acquired visually by a camera of the motor vehicle with information in the radiogram.

This, for example, produces the technical advantage that the check for content correctness can be carried out efficiently.

It is therefore in particular provided that a camera of the motor vehicle visually or optically acquires what the electronic display device of the traffic signaling device is transmitting or displaying. This is compared with or matched to the information in the radiogram.

This makes it possible to efficiently check whether the content of the radiogram, i.e. the information, corresponds to what the traffic signaling device is displaying by means of the display device.

In one example embodiment of the method according to the second aspect of the present invention, it is provided that, if the two pieces of information match, operation includes a reaction of the motor vehicle appropriate to the information.

This, for example, produces the technical advantage that the motor vehicle can be operated efficiently. The appropriate reaction depends on the individual case, i.e. the specific given situation. If the traffic signaling device is a traffic light system, for example, the motor vehicle reacts appropriately to a signal image of the traffic light system. If the light is red, the appropriate reaction is to stop; if the light is green light, the appropriate reaction is to cross the traffic light system as long as there are no collision objects in the path of the motor vehicle. In the case of an electronic traffic sign that is indicating a maximum permissible speed, for example, a possible appropriate reaction of the motor vehicle is for the motor vehicle to not drive faster than the maximum permissible speed, for instance making it necessary to decelerate the motor vehicle if the motor vehicle is driving faster than the maximum permissible speed.

An appropriate reaction is therefore in particular a reaction to the information being output by the traffic signaling device, be it by radiogram or by display device.

In one example embodiment of the method according to the second aspect of the present invention, it is provided that, if there is a difference between the two pieces of information, renewed checking of a next telegram received by the motor vehicle and transmitted by the traffic signaling device is carried out.

This, for example, produces the technical advantage that it is possible to rule out the potential of hitting the exact moment or point in time, in which a radiogram still includes the information that a traffic light system is still emitting a green signal light, i.e. colloquially “is green”, for instance, but the traffic light system is already switching to a yellow signal light, i.e. colloquially “is yellow”. The same applies to an electronic traffic sign. In other words, for example, it produces the technical advantage that it is possible to rule out the potential of hitting the exact moment or point in time, in which a radiogram includes certain information that a traffic signaling device is still displaying certain information, but the traffic signaling device is already displaying different information. This generally ensures that optical switching and transmission of the radiogram that is not exactly simultaneous does not lead to problems.

In one example embodiment of the method according to the second aspect of the present invention, it is provided that renewed checking includes again comparing signal information of the traffic signaling device again acquired visually by a camera of the motor vehicle with information included in the next telegram.

This, for example, produces the technical advantage that renewed checking can be carried out efficiently. The above statements regarding the (initial) checking apply analogously to the renewed checking and vice versa.

In one example embodiment of the method according to the second aspect of the present invention, it is provided that if there is again a difference between the two pieces of information, the motor vehicle is operated on the basis of a safety concept.

This, for example, produces the technical advantage that the motor vehicle can be operated efficiently and safely. A safety concept includes reducing the speed of the motor vehicle, for example. A safety concept includes bringing the motor vehicle into a safe state, for example. A safety concept includes stopping the motor vehicle, for example.

In one example embodiment of the method according to the second aspect of the present invention, it is provided that checking is carried out on the basis of surroundings data which describe a surroundings of the motor vehicle.

This, for example, produces the technical advantage that checking can be carried out efficiently. Therefore, according to this embodiment, further information, the surroundings data, is available to carry out checking on the motor vehicle side.

According to an example embodiment of the present invention, these surroundings data include motor vehicle-generated surroundings data, for instance. Such surroundings data are therefore generated or produced by the motor vehicle. Such surroundings data, that can be produced by the motor vehicle, have, for instance, been ascertained using motor vehicle-internal surroundings sensors. A surroundings sensor of the motor vehicle can acquire a surroundings of the motor vehicle, for example, and output surroundings data based on said acquisition.

A surroundings sensor system within the meaning of the description comprises one or more surroundings sensors, for instance; examples of a surroundings sensor within the meaning of the description include the following surroundings sensors: radar sensor, LiDAR sensor, ultrasonic sensor, magnetic field sensor, infrared sensor, image sensor, in particular the image sensor of a video camera.

Surroundings data include motor vehicle-external surroundings data, for instance. Such surroundings data have been generated or produced outside the motor vehicle, for example, and sent to the motor vehicle. The motor vehicle therefore, for instance, receives such motor vehicle-external surroundings data. Such motor vehicle-external surroundings data include surroundings data from other motor vehicles, for example, and/or surroundings data ascertained on the infrastructure side. Within an infrastructure, for instance, there are several surroundings sensors that acquire their respective surroundings and thus, for example, also the surroundings of the motor vehicle, so that relevant surroundings data can be transmitted from the infrastructure to the motor vehicle.

The step of acquiring the surroundings of the motor vehicle using the surroundings sensors of the motor vehicle is included in the method according to the second aspect of the present invention, for example. The receiving of motor vehicle-external surroundings data by the motor vehicle, is included in the method according to the second aspect, for example.

In one example embodiment of the method according to the second aspect of the present invention, it is provided that a behavior of at least one traffic participant in the vicinity of the motor vehicle is ascertained based on the surroundings data, wherein checking is carried out on the basis of the behavior of the at least one traffic participant.

This, for example, produces the technical advantage that checking can be carried out efficiently. If the behavior of the at least one traffic participant indicates that the traffic participant is reducing his speed in front of a traffic light system, for example, the motor vehicle can, for instance, assume that the traffic light system is emitting red light.

A behavior of the at least one traffic participant can thus be a reaction of the at least one traffic participant to the signal information being provided or displayed by the traffic signaling device.

In one example embodiment of the method according to the second aspect of the present invention, it is provided that checking includes checking that the received radiogram is not a radiogram that is outdated or has been transmitted too late.

This, for example, produces the technical advantage that checking can be carried out efficiently.

A traffic signaling device is a traffic light system, for example, or an electronic traffic sign, for example.

The traffic signaling device according to the method according to the second aspect of the present invention can be the traffic signaling device according to the third aspect, for instance, or the traffic signaling device from the method according to the first aspect.

Features and technical functionalities of the method according to the first aspect of the present invention result analogously from corresponding technical functionalities and features of the method according to the second aspect of the present invention and/or the traffic signaling device according to the third aspect of the present invention and/or from the device according to the fourth aspect of the present invention, and vice versa.

Method features thus result analogously from corresponding device features and vice versa.

The method according to the first aspect of the present invention is a computer-implemented method, for example.

The method according to the second aspect of the present invention is a computer-implemented method, for example.

The device is, for instance, programmed to execute a computer program which comprises instructions that, when the computer program is executed by a computer, cause said computer to carry out a method according to the second aspect of the present invention.

The traffic signaling device is, for instance, programmed to execute a computer program which comprises instructions that, when the computer program is executed by a computer, cause said computer to carry out a method according to the first aspect of the present invention.

An electronic display device comprises one or more signal groups, for example.

The visual display of the new actual information by the electronic display device of the traffic signaling device can also include a dark phase according to which the display device remains switched off. A switched-off electronic display device also visually displays new actual information: a failure of the traffic signaling device.

The embodiment examples and embodiments described here can be combined with one another in any way, even if this is not explicitly stated.

The present invention is explained in more detail in the following with reference to preferred embodiment examples.

### BRIEF DESCRIPTION OF THE DRAWINGS

FIG. 1 shows a flow chart of a method according to the first aspect of the present invention.

FIG. 2 shows a flow chart of a method according to the second aspect of the present invention.

FIG. 3 shows a traffic signaling device according to an example embodiment of the present invention.

FIG. 4 shows a device, according to an example embodiment of the present invention.

FIG. 5 shows a machine-readable storage medium, according to an example embodiment of the present invention.

FIG. 6 shows a motor vehicle approaching a traffic light system, according to an example embodiment of the present invention.

FIG. 7 shows a flow chart of a further method according to the second aspect of the present invention.

### DETAILED DESCRIPTION OF EXAMPLE EMBODIMENTS

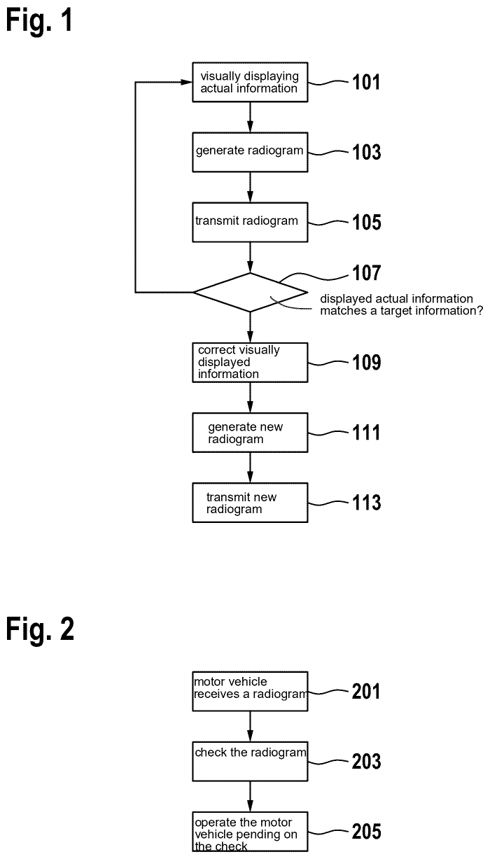

FIG. 1 shows a flow chart of a method for operating an electronic traffic signaling device, in particular a traffic light system or electronic traffic sign, comprising the following steps:
visually displaying 101 actual information by means of an electronic display device of the traffic signaling device,
generating 103 and transmitting 105 a radiogram comprising the actual information by means of the traffic signaling device,
checking 107 whether the displayed actual information matches a target information,
if it does not match, correcting 109 the visually displayed information in order to visually display new actual information by means of the electronic display device, and
generating 111 and transmitting 113 a new radiogram comprising the new actual information by means of the traffic signaling device.

If the displayed actual information matches the target information, the method can end or the method can be continued again at step 101.

For a traffic light system, the actual information is a current signal image, for instance. A target information is a target signal image, for instance.

For an electronic traffic sign, the actual information is a maximum permissible speed, for instance. The target information is the maximum possible target speed, for instance.

The target information is thus the information to be visually displayed by means of the electronic display device. The actual information is the information actually being displayed.

FIG. 2 shows a flow chart of a method for operating a motor vehicle, comprising the following steps:
when the motor vehicle receives 201 a radiogram transmitted by an electronic traffic signaling device, in particular a traffic light system or an electronic traffic sign, outside of a heartbeat-based cycle, checking 203 by the motor vehicle the radiogram received outside of the heartbeat-based cycle for correctness of the radiogram, operating 205 the motor vehicle depending on the check for correctness.

Operating the motor vehicle includes at least partially automated control of a lateral and/or longitudinal guidance of the motor vehicle, for example.

The formulation “at least partially automated” includes: partially automated, highly automated, fully automated and autonomous.

Partially automated corresponds to a level of automation 2 according to the definition by the German Federal Highway Research Institute (BASt). Highly automated corresponds to a level of automation 3 according to the definition of the BASt. Fully automated corresponds to a level of automation 4 according to the definition of the BASt. Autonomous corresponds to a level of automation 5 according to the SAE (Society of Automotive Engineers).

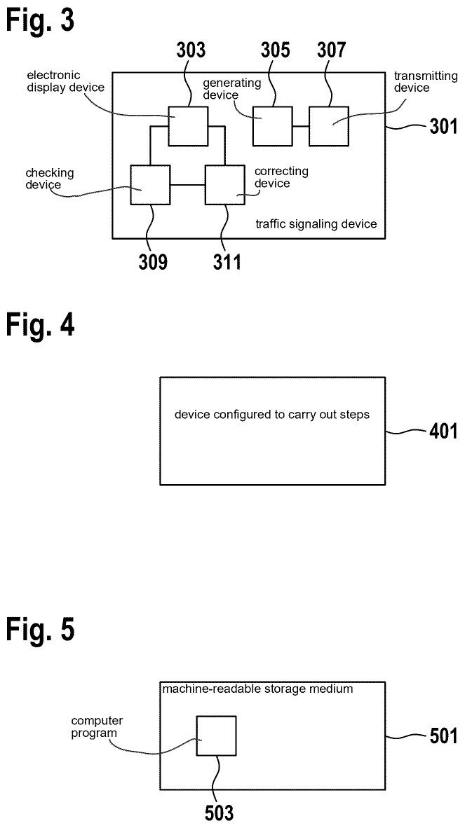

FIG. 3 shows a traffic signaling device 301, in particular a traffic light system or an electronic traffic sign, comprising:
an electronic display device 303, which is configured to visually display actual information,
a generating device 305, which is configured to generate a radiogram comprising the actual information,
a transmitting device 307, which is configured to transmit the generated radiogram,
a checking device 309, which is configured to check whether the displayed actual information matches a target information,
a correcting device 311, which is configured to correct the visually displayed information if it does not match in order to visually display a new actual information by means of the visual display,
wherein the generating device 305 is configured to generate a new radiogram comprising the new actual information, and
wherein the transmitting device 307 is configured to transmit the new radiogram.

The checking device comprises a sensor, for instance; for example an optical sensor, for optically acquiring the visually displayed information.

The checking device and the correcting device can be implemented in a common device, for example.

The correcting device is, for instance, implemented as a control device of the electronic display device.

The traffic signaling device is configured to carry out all steps of the method according to the first aspect, for instance.

The method according to the first aspect is, for instance, carried out by means of the traffic signaling device according to the third aspect.

FIG. 4 shows a device 401, which is configured to carry out all steps of the method according to the second aspect.

The method according to the second aspect is carried out by means of the device according to the fourth aspect, for example.

FIG. 5 shows a machine-readable storage medium 501 on which a computer program 503 is stored. The computer program 503 comprises instructions that, when the computer program 503 is executed by a computer, cause said computer to carry out a method according to the first aspect and/or according to the second aspect.

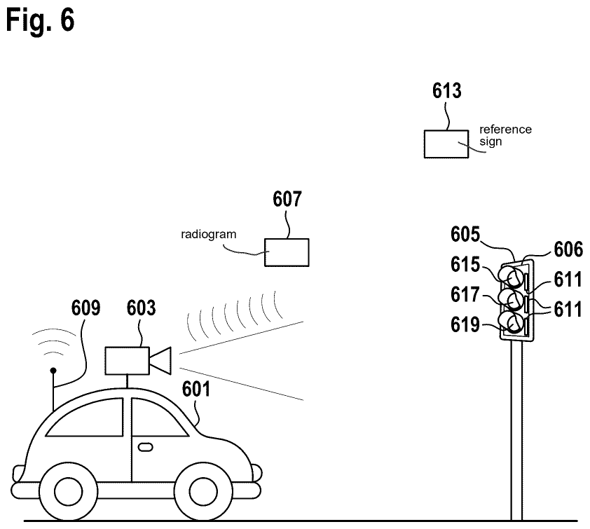

FIG. 6 shows a motor vehicle 601 comprising a camera 603. The motor vehicle 601 is approaching a traffic light system 605. The traffic light system 605 is a traffic light system according to the specification; is therefore in particular configured to carry out all steps of the method according to the first aspect.

The traffic light system 605 comprises a signal group 606 as an example of an electronic display device. The signal group 606 can be used to display a specific signal image. The signal group 606 includes three signal lights: a first signal light 615 that can emit red light, a second signal light 617 that can emit yellow light, and a third signal light 619 that can emit green light.

The signal image displayed by the signal group 606 is thus, on the one hand, transmitted visually. On the other hand, the traffic light system 605 transmits a radiogram 607 that includes the displayed signal image as information.

The motor vehicle 601 can thus, on the one hand, acquire the displayed signal image visually using the camera 603. On the other hand, the motor vehicle 601 can receive the radiogram 607 using a radio interface 609 and thus obtain knowledge of the displayed signal image in this way as well.

The radiograms 607 are transmitted by means of the traffic light system 605 using a heartbeat-based cycle, for instance.

The traffic light system 605 comprises three optical sensors 611, one for each of the three signal lights 615, 617, and 619. This means that each one of the three optical sensors 611 can optically acquire signal light emitted by the respective signal light 615, 617, 619, so that the displayed signal image can be optically acquired by the three sensors 611. The optically acquired signal image is then compared with the signal image to be transmitted by the signal group 606. The actually displayed signal image is thus compared with a target signal image.

If they do not match, the displayed signal image is corrected immediately, for example by displaying the correct, i.e. the target, signal image, or by switching the signal group 606 to a dark phase. Then a new radiogram is generated and transmitted, wherein the new radiogram comprises the information relating to what the signal group 606 is transmitting after the originally displayed information has been corrected. This can therefore include the information that the signal image corresponds to a dark phase, for example, or the correct signal image.

In this case, the traffic light system 605 does not wait until the next heartbeat cycle; the new radiogram is instead transmitted immediately, i.e. without unnecessary delay. The new radiogram is labeled with the reference sign 613 for example.

In accordance with the embodiments described here, the motor vehicle 601 now checks whether such a radiogram received outside the heartbeat cycle is a correct radiogram. If this radiogram is a correct radiogram, the motor vehicle 601 reacts accordingly.

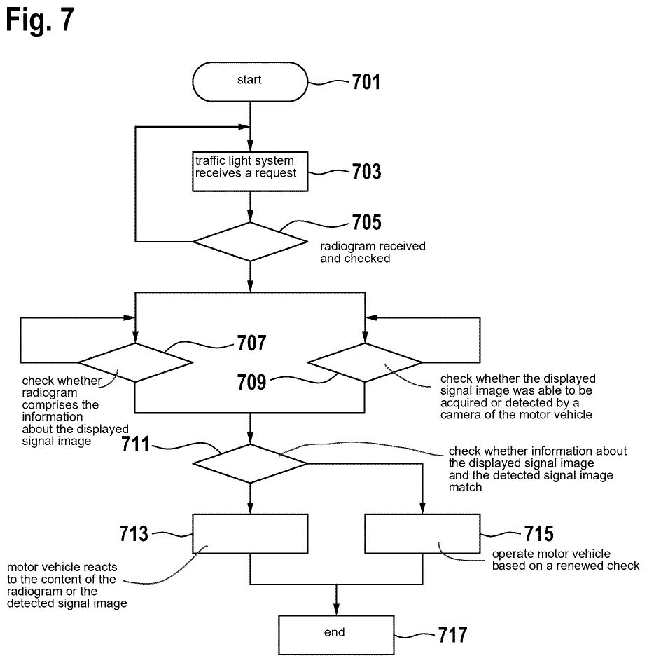

FIG. 7 shows a flow chart of a further method according to the second aspect.

The method starts at block 701.

According to a step 703, a traffic light system receives a request for its current signal image. According to a step 705, a radiogram is received and there is a check to see whether this radiogram is from the traffic light system, i.e. whether the received radiogram is a response to the request according to step 703. This can be derived from the received radiogram, for example, because the information about the type of traffic signaling device, i.e. traffic light system or electronic traffic sign, is part of the radiogram.

At step 707, there is a check to see whether the radiogram comprises the information about the displayed signal image.

In step 709, there is a check to see whether the displayed signal image of the traffic light system was able to be acquired or detected by means of a camera of the motor vehicle.

If both steps of checking 707, 709 are positive, there is a check in step 711 to see whether the information about the displayed signal image and the detected signal image match.

If they match, the method continues in step 713. According to step 713, it is therefore provided that the motor vehicle reacts appropriately to the content of the radiogram or the detected signal image.

If they do not match, the method continues in step 715. A repeated check using a newly received radiogram and a renewed optical acquisition of the traffic light system is provided here, for example, as already described above. In step 715, it can then be provided that the motor vehicle is operated based on the renewed check.

The method ends in step 717.

The method according to the second aspect is therefore in particular directed toward ensuring that a motor vehicle, in particular an at least partially automated motor vehicle, can reliably react to traffic light systems or electronic traffic signs and carry out its driving task accordingly.

The basis of the method according to the second aspect is in particular that there is a redundant and/or diverse acquisition of the status of the traffic light system or the electronic traffic sign. The status is acquired using a motor vehicle-internal surroundings sensor system, for example, in particular a camera.

The motor vehicle detects a current signal image of the traffic light system or a traffic sign displayed by the electronic traffic sign, for instance, and evaluates the sensor data accordingly.

The status is a signal image, for example, or the displayed traffic sign, for example, for instance a maximum permissible speed or a lane closure.

A position of the traffic signaling device is known to the motor vehicle, for instance. The type of the traffic signaling device is known to the motor vehicle, for instance. The motor vehicle can have this knowledge from a digital road map, for example, and/or by querying a remote database which can be implemented in a cloud infrastructure, for instance.

The motor vehicle also acquires the current status by receiving a radiogram transmitted by the traffic signaling device.

According to one embodiment, the radiogram additionally comprises further data, for example the type and/or position of the traffic signaling device.

The position and/or the type of traffic signaling device can, for instance, be used by the motor vehicle to detect the traffic signaling device.

The traffic signaling device transmits the radiograms as a broadcast, for example; i.e. to all motor vehicles without a specific request from a motor vehicle.

The traffic signaling device only transmits a radiogram upon request from a motor vehicle, for example.

If the information matches, the motor vehicle can plan its driving task according to the current status. If the information does not match, one or more renewed checks can be carried out. If the information does not match or if the information does not match again, the motor vehicle can be operated based on a safety concept, for example.

The safety concept includes restricting a driving function, for example, in particular an at least partially automated driving function.

It should be noted here that embodiments made in connection with an electronic traffic sign and/or a traffic light system apply analogously to traffic signaling devices in general and vice versa.

Within the traffic signaling device (traffic light system or electronic sign), it is in particular provided that the current state (ACTUAL) is compared with the target state (TARGET). As long as TARGET=ACTUAL, a radiogram containing information about the current state can be generated and transmitted in cyclical repetitions (e.g. with a frequency of 15 Hz).

For example, it is provided that the radiogram not only be transmitted cyclically, but that the radiograms also be made identifiable in the order in which they are transmitted.

In order to comply with the standards for functional safety (e.g. ISO 26262 in the automotive sector or IEC 61508), for example, it is provided that the TARGET/ACTUAL comparison be secured. This can, for instance, be accomplished by using redundant and diverse hardware and/or software, safety-certified hardware or both.

As soon as a difference between TARGET and ACTUAL is detected, mechanisms are already in place in the traffic signaling device, in particular the traffic light system, which is a safety-critical device, that are intended to ensure that the visual display can never erroneously transmit harmful information, e.g. simultaneous green for two incompatible traffic flows. This is now extended to that, immediately after the correction of the visual display in the traffic signaling device, in particular the traffic light system, a new radiogram with the same state information as the corrected visual display (=new ACTUAL state) is generated and transmitted. The same applies to an electronic sign; if the TARGET and ACTUAL states deviate unintentionally, which can also include the failure of the display, the information relating to the displayed ACTUAL state is transmitted as a radiogram. The transmission of the new ACTUAL state takes place so promptly, for example, (e.g. ideally up to max. 100-200 ms) that information is available to all traffic participants in the vicinity of the traffic signaling device practically simultaneously, regardless of whether it is received visually or by radio.

In order for the information to then also be considered functionally safe or reliable, it is, for example, provided that it is transmitted on time and with a regular frequency. On the receiver side, i.e. in particular on the motor vehicle side, a corresponding so-called safety endpoint (the device according to the second aspect) is provided in the motor vehicle as well. This, for example, is hardware and software that is sufficiently certified in terms of safety and that monitors the communication.

This monitoring includes, for example:
1. Checking whether the radiograms (as long as TARGET=ACTUAL in the transmitting traffic signaling device) are received in the defined time intervals (e.g. 66 ms, corresponds to a frequency of 15 Hz) and without losses or in the right order. The transmitting traffic signaling device can thus be considered “available”.

If the radiogram is not received in time, in the wrong order and/or with “gap” in the order, this is reported, for example by means of the “safety endpoint” in the motor vehicle. Depending on the respective case, it can then be decided whether the information is still sufficiently frequently and reliably or no longer available. If the information is no longer reliably available, the motor vehicle can fall back on internal detection or alternative internal strategies, for instance.
2. Checking the received radiograms for correctness and completeness. This is accomplished using checksums, for example.

Here too, the “safety endpoint” in the motor vehicle in particular reports whether the information can still be relied upon (e.g. because the safety argumentation has shown that up to 3 radiograms in a row can fail without causing problems) or not.

The “safety endpoint” takes over the “unpacking” of the radiograms, for example, and is implemented on hardware that is sufficiently certified in terms of safety, for instance, to be able to guarantee that the information has always been transmitted correctly and unadulterated from the transmitting traffic signaling device to the critical component in the motor vehicle.

This is the only way to achieve secure (secure in the sense of the English terms “safe” and “secure”) and reliable end-to-end information transmission despite an inherently insecure transmission via a radio link, or to evaluate whether the information is reliably received or not, which can then mean switching to motor vehicle-internal solution strategies for the respective situation.

Within the meaning of the description, “secure” in particular means “safe” and “secure”. Although these two English terms are usually translated into German as “sicher,” they can have different meanings in English.

The term “safe” refers in particular to the topic of accidents and accident prevention. “Safe” therefore in particular means that measures are taken to ensure the correct function and a correct flow of the method or methods.

The term “secure” is used in particular to refer to the topic of computer protection and hacker protection, i.e. in particular: How secure are components from unauthorized access and data manipulation by third parties, so-called hackers? Something that is “secure” therefore in particular has adequate and sufficient computer protection and hacker protection.

To additionally ensure that the reliably received information is relevant to the motor vehicle, it is, for example, provided that the position of the traffic signaling device or the location to which it applies is also part of the transmitted radiogram.

The following information is additionally provided, for instance:
1. Type of the traffic signaling device
   a. Traffic light system
   b. Sign (including which type)
2. Traffic light system:
   a. Position
   b. Signal group(s)
   c. Assignment to lane(s)
3. Sign:
   a. Position (possibly also the height)
   b. Lane(s) (in the case of bridges, overpasses & underpasses also the height)

The following describes an example of what happens in a motor vehicle when a radiogram is received out of sequence, i.e. outside of a heartbeat-based cycle-this does not necessarily have to correspond to an error, but it may indicate that something has changed in the status of the traffic signaling device or that there is a difference between an optical display and previously digitally transmitted state.

If the traffic signaling device, which can be a traffic light system or an electronic sign, detects that the optically displayed signal does not correspond to the content of the most recently transmitted radiogram, it immediately corrects this by transmitting a new radiogram with the correct content.

For the motor vehicle, this means that a radiogram is received outside of the expected heartbeat-based cycle.

One or more of the following steps are then carried out on the motor vehicle side:
Checking whether the received radiogram satisfies the necessary safety and security requirements.
This also includes checking that is not an outdated radiogram, e.g. a radiogram that has been transmitted too late.
A correct radiogram outside of the expected cycle means an unexpected change:

The signal information visually detected by the motor vehicle (for example traffic light system state or traffic sign information) is compared with the information in the radiogram.
i. If the two match: act accordingly.
ii. If they differ: Renewed check(s);

Next radiogram+new visual information
iii. Still different: Motor vehicle follows its safety concept; e.g. reduce speed.

In parallel to the checks, the motor vehicle can optionally also check the surroundings based on its surroundings information or further data from other motor vehicle-external signals. This check includes checking whether there are irregularities in the traffic, for example; for instance because other traffic participants are already reacting to “incorrect” signals from the traffic signaling device.

What is claimed is:

1. A method for operating an electronic traffic signaling device, wherein the electronic traffic signaling device is a traffic light system or an electronic traffic sign, the method comprising the following steps:
visually displaying actual information using an electronic display device of the traffic signaling device;
generating and transmitting a radiogram including the actual information using the traffic signaling device;
checking whether the displayed actual information matches a target information;
when the displayed actual information does not match the target information, correcting the visually displayed information in order to visually display new actual information using the electronic display device; and
generating and transmitting a new radiogram including the new actual information using the traffic signaling device.

2. The method according to claim 1, wherein the radiogram including the actual information is transmitted using a heartbeat-based cycle, wherein it is determined that the new radiogram including the new actual information may be transmitted outside of the heartbeat-based cycle, so that the new radiogram is transmitted immediately after being generated without waiting until the next cycle to transmit.

3. The method according to claim 1, wherein radiograms are generated such that the radiograms include one or more of the following additional information: type of traffic signaling device; position of the traffic signaling device; application range of the traffic signaling device; in the case of a traffic light system, information relating to one or more signal groups; in the case of a traffic light system, information relating to an assignment to one or more lanes; in the case of an electronic traffic sign, height of the traffic sign; in the case of an electronic traffic sign, assignment to one or more lanes.

4. The method according to claim 1, wherein the checking includes optical checking using an optical sensor of the traffic signaling device.

5. The method according to claim 1, wherein the radiogram is generated such that the radiogram includes a value of a counter that is incremented or decremented after transmission of the radiogram.

6. A method for operating a motor vehicle, comprising the following steps:
when the motor vehicle receives a radiogram transmitted by an electronic traffic signaling device, including a traffic light system or an electronic traffic sign, outside of a heartbeat-based cycle, checking by the motor vehicle the radiogram received outside of the heartbeat-based cycle for correctness of the radiogram; and
operating the motor vehicle depending on the check for correctness.

7. The method according to claim 6, wherein the checking for correctness includes checking for formal and/or content correctness.

8. The method according to claim 7, wherein the checking for formal correctness includes checking whether at least one safety condition is satisfied by the radiogram.

9. The method according to claim 7, wherein checking for content correctness includes comparing signal information of the traffic signaling device acquired visually by a camera of the motor vehicle with information in the radiogram.

10. The method according to claim 9, wherein, when the signal information and the information in the radiogram match, the operating includes a reaction of the motor vehicle appropriate to the information.

11. The method according to claim 9, wherein, when there is a difference between the signal information and the information in the radiogram, renewed checking of a next radiogram received by the motor vehicle and transmitted by the traffic signaling device is carried out.

12. The method according to claim 11, wherein the renewed checking includes again comparing signal information of the traffic signaling device again acquired visually by a camera of the motor vehicle with information included in the next radiogram.

13. The method according to claim 12, wherein, when there is again a difference between the signal information and the information included in the next radiogram, the motor vehicle is operated based on a safety concept.

14. The method according to claim 6, wherein the checking is carried out based on surroundings data which describe a surroundings of the motor vehicle.

15. The method according to claim 14, wherein a behavior of at least one traffic participant in the vicinity of the motor vehicle (601) is ascertained based on the surroundings data, wherein checking is carried out on the basis of the behavior of the at least one traffic participant.

16. The method according to claim 6, wherein checking includes checking that the received radiogram is not a radiogram that is outdated or has been transmitted too late.

17. A traffic electronic traffic sign, comprising:
an electronic display device configured to visually display actual information;
a generating device configured to generate a radiogram including the actual information;
a transmitting device configured to transmit the generated radiogram;
a checking device configured to check whether the displayed actual information matches a target information;
a correcting device configured to correct the visually displayed information when the visually displayed information does not match the target information in order to visually display a new actual information using the visual display;
wherein the generating device is configured to generate a new radiogram including the new actual information; and
wherein the transmitting device is configured to transmit the new radiogram.

18. A device configured to operate a motor vehicle, the device configured to:
when the motor vehicle receives a radiogram transmitted by an electronic traffic signaling device, including a traffic light system or an electronic traffic sign, outside of a heartbeat-based cycle, check by the motor vehicle the radiogram received outside of the heartbeat-based cycle for correctness of the radiogram; and
operate the motor vehicle depending on the check for correctness.

19. A non-transitory machine-readable storage medium on which is stored a computer program for operating an electronic traffic signaling device, wherein the electronic traffic signaling device is a traffic light system or an electronic traffic sign, the computer program, when executed by a computer, causing the computer to perform the following steps:
visually displaying actual information using an electronic display device of the traffic signaling device;
generating and transmitting a radiogram including the actual information using the traffic signaling device;
checking whether the displayed actual information matches a target information;
when the displayed actual information does not match the target information, correcting the visually displayed information in order to visually display new actual information using the electronic display device; and
generating and transmitting a new radiogram including the new actual information using the traffic signaling device.
